(19) United States
(12) Patent Application Publication
(10) Pub. No.: US 2012/0206013 A1
(43) Pub. Date: Aug. 16, 2012

(54) MODES OF OPERATION OF PIEZOELECTRIC MOTOR

(76) Inventor: Benny Gaber, Haifa (IL)

(21) Appl. No.: 13/500,355

(22) PCT Filed: Oct. 12, 2010
(86) PCT No.: PCT/US10/52210

§ 371 Date: Apr. 5, 2012

Related U.S. Application Data
(60) Provisional application No. 61/251,779, filed on Oct. 15, 2009.

(51) Int. Cl. H02N 2/12

(52) U.S. Cl. 310/323.02

(57) ABSTRACT

A piezoelectric motor (1) including a rotor (3), a stator (2) including a piezoelectric material having axial polarization, the stator (2) including at least three pairs of electrodes (5, 6) and a common electrode on a base end face thereof, and slabs (4) affixed to the stator (2) at spacings between the electrodes (5, 6), characterised in that the electrodes (5, 6) include a first set of electrodes B and a second set of electrodes R, the electrodes (B, R) receiving electrical driving signals from a controller (29) and being isolated from one another, and the controller (29) has a mode of operation wherein the B electrodes and the R electrodes receive phase shifted sinusoidal electrical signals creating three standing waves under tips of the slabs (4).

### FIELD OF THE INVENTION

The present invention relates generally to piezoelectric motors, such as a tube piezoelectric rotary-stage-less motor with a coned connection rotor.

### BACKGROUND OF THE INVENTION

There are many devices based on the piezoelectric effect. These devices are widely in use in ultrasound transducers and actuators. Piezoelectric actuators or motors are also very well known for rotating a stage with “stick-slip” friction contact.

Applicant's PCT Published Patent Application WO 2009/037693 (PCT/IL2008/001217), the disclosure of which is incorporated herein by reference, describes a novel slip-stick piezoelectric motor.

### SUMMARY OF THE INVENTION

The present invention seeks to provide modes of operation for a rotary piezoelectric motor/actuator, such as the piezoelectric motor/actuator of WO 2009/037693.

There is thus provided in accordance with an embodiment of the invention a piezoelectric motor including a rotor, a stator including a piezoelectric material having axial polarization, the stator including at least three pairs of electrodes spaced from one another on a top end face thereof and a common electrode on a base end face thereof, and slabs affixed to the stator at spacings between the electrodes, wherein the rotor is pressed towards the slabs by a pre-load force, wherein when a positive charge is applied to a first of the electrodes and a negative charge is applied to a second of the electrodes and an electric common port is applied to the common electrode, it creates an electrical field and by the piezoelectric coefficient D₃₃ piezoelectric phenomenon causes an area under the first of the electrodes to move in one direction with respect to the base end face and an area under the second of the electrodes to move in a direction opposite to that of the first of the electrodes, thereby causing the spacings between the electrodes to bend and the slabs to tilt, thus applying a frictional pushing side force against the rotor to cause the rotor to rotate, characterised in that the electrodes include a first set of electrodes B and a second set of electrodes R, wherein each of the first set of electrodes B are counterclockwise adjacent to each of the slabs, and each of the second set of electrodes R are clockwise adjacent to each of the slabs, the electrodes (B, R) receiving electrical driving signals from a controller, and the controller has a mode of operation wherein the B electrodes and the R electrodes receive phase shifted sinusoidal electrical signals creating three standing waves under tips of the slabs.

In accordance with an embodiment of the invention the phase shifted sinusoidal electrical signals are at a natural frequency of the stator.

In accordance with an embodiment of the invention the phase shifted controls the direction of the rotor rotation.

In accordance with an embodiment of the invention the controller has another mode of operation wherein a sinusoidal electrical signal is applied to the R and common electrodes only or to the B and common electrodes only.

In accordance with an embodiment of the invention the controller has another mode of operation wherein opposite DC electrical signals are applied to the B and R electrodes.

In accordance with an embodiment of the invention the controller has another mode of operation wherein a DC electrical signal is applied to the B and opposite electrical sign signal to the R electrodes relative to the common electrode, thus tilting the slabs linearly according to the voltage applied and rotating the rotor.

In accordance with an embodiment of the invention the controller has another mode of operation wherein a DC electrical signal is applied to only one of the B and R electrodes.

### BRIEF DESCRIPTION OF THE DRAWINGS

The disclosed technique will be understood and appreciated more fully from the following detailed description taken in conjunction with the drawings in which:

FIG. 1 is a schematic general view illustration of a seek mode of operation for a piezoelectric motor, in accordance with an embodiment of the present invention.

FIG. 2 is a schematic general view illustration of a track mode of operation for a piezoelectric motor, in accordance with an embodiment of the present invention.

### DETAILED DESCRIPTION OF EMBODIMENTS

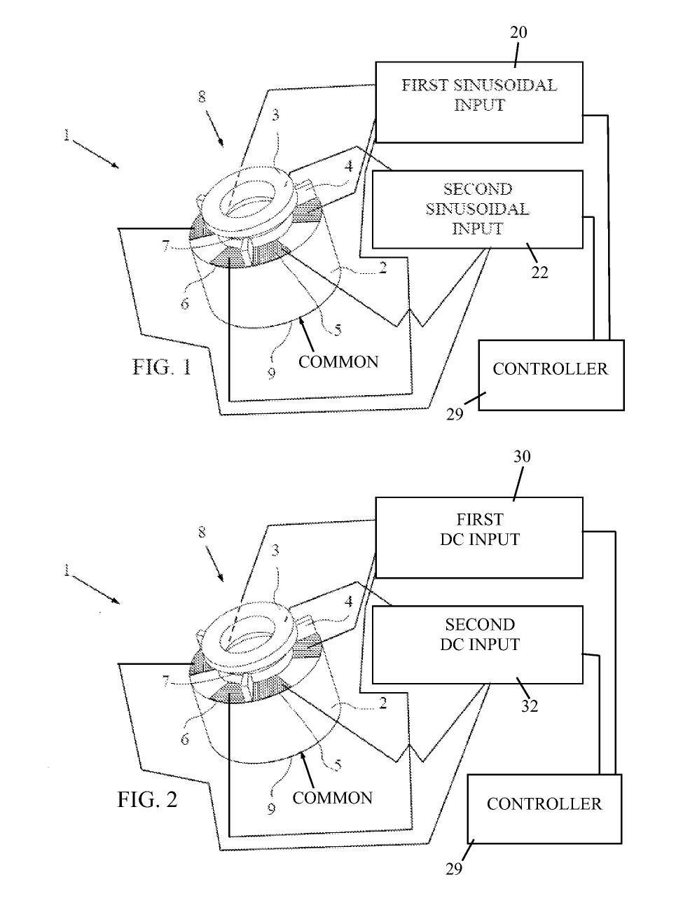

Reference is now made to FIG. 1, which illustrates a piezoelectric (rotary) motor 1 (or piezomotor for short) including a stator 2, electrodes 5 and 6, a slab 4 and a rotor 3, constructed and operative in accordance with a non-limiting embodiment of the present invention. The motor may be constructed as described in PCT Published Patent Application WO 2009/037693 (PCT/IL2008/001217), but has the added novel feature of seek and track, as will be explained.

The stator 2 of the piezoelectric rotary motor 1 is made from a piezoelectric crystal material tube, coated with pairs of two separate conductive coating segmented electrodes 5 and 6 on the top end face. Slabs 4 (made of a hard material, such as ceramic) are affixed to the stator 2 at spacings between the pairs of electrodes 5 and 6. The rotor 3 is formed with a cone shaped side 7. The rotor 3 is pressed towards the slabs 4 via a preload force directed along the stator 2 in an axial direction 8. The piezoelectric crystal material tube of the stator 2 is polarized along the axial axis of the stator 2 in the direction indicated by arrow 8. Slabs 4 preferably have a shape (e.g., rounded or chamfered tips) to match the contour of the rotor cone 7.

When a positive charge is applied to electrodes 5 and a negative charge is applied to electrodes 6, with an electric common port being applied to the base end face common electrode 9, the so-called D₃₃ piezoelectric phenomenon is created, which causes the area under electrode 5 to move in one direction with respect to the base end face 9 and the area under electrode 6 to move in the opposite direction, thereby causing the spacings between the electrodes to bend and the slabs to tilt, thus applying a frictional pushing side force against rotor 3 to cause rotor 3 to rotate. The voltage may be greater at one of the electrodes than the other, thereby lifting and rotating slabs 4, as well as increasing a contact force between slabs 4 and rotor 3.

In accordance with an embodiment of the present invention, the stator 2 can be operated using two distinct modes of operation, “seek” (AC) and “track” (DC). In this manner, both speed and accuracy can be achieved, which can be used, for example, to achieve HDD (hard disk drive) track density requirements. Each of these two modes and its sub modes of operation can be used as needed - separately or in sequence real time combinations for optimum time response and accuracy.

The electrodes on the face of the piezo-stator 2 include a first set of electrodes B and a second set of electrodes R, wherein each of the first set of electrodes B are counterclockwise adjacent to each of the slabs 4, and each of the second set of electrodes R are clockwise adjacent to each of the slabs 4. The first set of electrodes B is isolated from the second set of electrodes R as seen in the drawing. The electrodes receive electrical driving signals from a controller 29, which is capable of selecting between any of the modes of operation.

The seek and track modes include, but are not limited to, the following:

“Seek Fast”—This is a mode in which the electrodes on the face of the piezo-stator (the three B electrodes and the three R electrodes) receive phase shifted sinusoidal electrical signals (in the stator's ring natural frequency, which is about 130 KHz, for example) creating three standing waves under the three tips of slabs 4. This results in the motor rotor receiving many impulses, creating the so-called “stick-slip” motion, keeping the rotor in a fast rotary movement. (Stick-slip motion is described, e.g., in http://en.wikipedia.org/wiki/Stick-slip). This mode is applicable when the HDD arm needs to move fast from one area of the disc to another.

In this mode, the motor receives only “on” or “off” commands from the driver with the appropriate phase shift value according CW or CCW direction of rotation. Since the distance from the off command to a full stop position is known, accurate vicinity is reached to the sought area.

“Seek Slow”—This is a mode in which a slow continuous movement is needed. The input sine signal in the natural frequency is applied to the R and common electrodes only or B and common electrodes only, depending on the desired rotational direction.

“Second Seek Slow” is a mode as in “seek fast” but using a lower electrical volt value.

“Track” (track following)—This is a mode in which the B and R electrodes on the face of the piezo-stator receive a DC electrical voltage, thereby creating an actuator wherein the slab tilts while the tip still in contact with the rotor 3. In an HDD application, this secondary mode is implemented after the HDD arm has been moved to the designated area, near the desired track by the seek mode, and is used to move the arm to the individual track and then follow this track in order to maintain the on-track stability (as the disc rotates). The goal is to achieve a discrete movement of 0.1 nanometers.

There are two sub-modes regarding the “Track” mode:

“Track Coarse”—here the B and R electrodes receive opposite electrical voltages (i.e., one negative and the other positive) relative to the common electrode.

“Track Fine”—here only the B or R electrodes receive electrical voltage.

It is appreciated that various features of the invention which are, for clarity, described in the contexts of separate embodiments, may also be provided in combination in a single embodiment. Conversely, various features of the invention which are, for brevity, described in the context of a single embodiment, may also be provided separately or in any suitable subcombination.

1. A piezoelectric motor comprising:
a rotor;
a stator comprising a piezoelectric material having axial polarization, said stator comprising at least three pairs of electrodes spaced from one another on a top end face thereof and a common electrode on a base end face thereof; and
slabs affixed to said stator at spacings between said electrodes, wherein said rotor is pressed towards said slabs by a pre-load force;
wherein when a positive charge is applied to a first of said electrodes and a negative charge is applied to a second of said electrodes and an electric common port is applied to said common electrode, D₃₃ piezoelectric phenomenon is created which causes an area under the first of said electrodes to move in one direction with respect to the base end face and an area under the second of said electrodes to move in a direction opposite to that of the first of said electrodes, thereby causing the spacings between the electrodes to bend and said slabs to tilt, thus applying a frictional pushing side force against said rotor to cause said rotor to rotate;
and wherein said electrode comprise a first set of electrodes and a second set of electrodes wherein each of the first set of electrodes are counterclockwise adjacent to each of said slabs, and each of the second set of electrodes are clockwise adjacent to each of said slabs, said sets of electrodes receiving electrical driving signals from a controller and being isolated from one another, and said controller has a mode of operation wherein said first set of electrodes and said second set of electrodes receive phase shifted sinusoidal electrical signals creating three standing waves under tips of said slabs.

2. The piezoelectric motor according to claim 1, wherein said phase shifted sinusoidal electrical signals are at a natural frequency of said stator.

3. The piezoelectric motor according to claim 1, wherein said controller has another mode of operation wherein a sinusoidal electrical signal is applied to said second set electrodes and common electrodes only or to said first set of electrodes and common electrodes only.

4. The piezoelectric motor according to claim 1, wherein said controller has another mode of operation wherein a DC electrical signal is applied to said first set and said second set of electrodes.

5. The piezoelectric motor according to claim 1, wherein said controller has another mode of operation wherein opposite DC electrical signals are applied to said first set and said second set of electrodes.

6. The piezoelectric motor according to claim 1, wherein said controller has another mode of operation wherein a DC electrical signal is applied to only one of said first set and said second set of electrodes.

7. A piezoelectric motor comprising:
a rotor;
a stator comprising a piezoelectric material having axial polarization, said stator comprising at least three pairs of electrodes spaced from one another on a top end face thereof and a common electrode on a base end face thereof; and
slabs affixed to said stator at spacings between said electrodes, wherein said rotor is pressed towards said slabs by a pre-load force;
wherein when a positive charge is applied to a first of said electrodes and a negative charge is applied to a second of said electrodes and an electric common port is applied to said common electrode, D₃₃ piezoelectric phenomenon is created which causes an area under the first of said electrodes to move in one direction with respect to the base end face and an area under the second of said electrodes to move in a direction opposite to that of the first of said electrodes, thereby causing the spacings between the electrodes to bend and said slabs to tilt, thus applying a frictional pushing side force against said rotor to cause said rotor to rotate;
and wherein said electrodes comprise a first set of electrodes and a second set of electrodes, wherein each of the first set of electrodes are counterclockwise adjacent to each of said slabs, and each of the second set of electrodes are clockwise adjacent to each of said slabs, said sets of electrodes receiving electrical driving signals from a controller and being isolated from one another, and said controller selects between two modes of operation, wherein one mode of operation said first set of electrodes and said second set of electrodes receive phase shifted sinusoidal electrical signals creating three standing waves under tips of said slabs and in another mode of operation a DC electrical signal is applied to said first set and said second set of electrodes.
